(19) United States
(12) Patent Application Publication
(10) Pub. No.: US 2026/0208326 A1
(43) Pub. Date: Jul. 23, 2026

(54) MULTI-PURPOSE DRIVER

(71) Applicant: New Revo Brand Group, LLC, Maple Grove, MN (US)

(72) Inventors: Ryan Smith, Woodbury, MN (US); Matthew C. Morris, Golden Valley, MN (US); Ryan Chernik, New Brighton, MN (US); Howard Tripp, Plymouth, MN (US); Dustin Sanchez, Minneapolis, MN (US)

(21) Appl. No.: 19/032,363

(22) Filed: Jan. 20, 2025

(51) Int. Cl. B25B 13/46; B25B 13/06; B25B 23/00; B25B 23/16

(52) U.S. Cl. CPC B25B 13/46; B25B 13/06; B25B 23/0021; B25B 23/16

(57) ABSTRACT

A multi-purpose driver can include a tool and an extension arm. The tool can have a body, a handle, a ratchet with a first hex socket near a first end of the body, a second hex socket near a second, opposite end of the body, and a third hex socket on a first end of the handle that is perpendicular to the first hex socket. The extension arm can have an elongate arm and a hex shaft. The first end of the handle can be on an opposite end of the tool than the first end of the body. The first, second, and third hex sockets can receive the hex shaft of the extension arm, the first and second hex sockets can be on the same face of the body, and at least the second and third hex sockets can have a solid interior bottom.

### FIELD OF THE INVENTION

This disclosure relates to a multi-purpose driver, and more particularly, relates to a driver having a tool body and handle with a plurality of connection points for an extension arm.

### BACKGROUND OF THE INVENTION

During maintenance or construction activities, drivers are often needed to loosen and/or tighten components. However, the objects being worked upon sometimes have fasteners that are difficult to reach or to maneuver with a standard driver. Therefore, it is desirable to provide a multi-purpose driver that can accommodate difficult-to-reach or difficult-to-maneuver fasteners.

### SUMMARY OF THE INVENTION

This disclosure relates to a multi-purpose driver, and more particularly, relates to a having a tool body and handle with a plurality of connection points for an extension arm. In an illustrative but non-limiting example, the disclosure provides a multi-purpose driver comprising a tool and an extension arm. The tool can have a body and a handle, a ratchet with a first hex socket disposed near a first end of the body on a first face of the body, a second hex socket disposed near a second end of the body, wherein the second end of the body is opposite the first end of the body, and a third hex socket on a first end of the handle. The first end of the handle can be located on an opposite end of the tool than the first end of the body, and an opening for the third hex socket can be on a handle face that is perpendicular to the first hex socket. The body of the tool can define the first hex socket and the second hex socket. The handle can define the third hex socket. A second face of the body can be located opposite the first face of the body. The second end of the body and a second end of the handle can be integrally formed. The body and the handle can share a center axis. The extension arm can have an elongate arm having a rounded outer surface, a first face on a first end, and a second face on a second end, and a hex shaft protruding from the first face of the elongate arm. The first, second, and third hex sockets can be configured to receive the hex shaft of the extension arm. The elongate arm can have a width that is larger than a width for any of the first, second, and third hex sockets. The first face of the elongate arm may be wider than the width of the first, second, and third hex sockets, thereby preventing the elongate arm from insertion into the first, second, or third hex sockets. In some cases, the elongate arm may be cylindrical.

In some cases, the second face of the elongate arm can include a fourth hex socket. In some cases, the second hex socket may be located on the first face of the body. In some cases, the first face and the second face of the body may be flat faces. In some cases, the first hex socket can have a hex opening on the first face of the body and a ratchet wheel on the second face of the body. And in some cases, the first, second, and third hex sockets can have openings of a similar size.

In some cases, the handle of the tool may be knurled and at least a portion of the elongate arm may be knurled inclusive of the rounded outer surface near the first end. In some cases, an opening of the second hex socket can sit proud from the body of the tool. In some cases, the rounded outer surface of the extension arm may be devoid of tools or openings. In some cases, the elongate arm of the extension arm can have a length that is at least 50% of a length of the tool. And in some cases, the elongate arm of the extension arm can have a length that is at least twice as long as a length of the hex shaft.

In another illustrative but non-limiting example, the disclosure provides a multi-purpose driver tool. The tool can have a body and a handle, a ratchet with a first hex socket disposed near a first end of the body on a first face of the body, a second hex socket disposed near a second end of the body, wherein the second end of the body is opposite the first end of the body, and a third hex socket on a first end of the handle. The first end of the handle can be located on an opposite end of the tool than the first end of the body, and an opening for the third hex socket can be on a handle face that is perpendicular to the first hex socket. The body of the tool can define the first hex socket and the second hex socket. The handle can define the third hex socket. The first, second, and third hex sockets can have openings of a similar size. A second face of the body can be located opposite the first face of the body. The second end of the body and a second end of the handle can be integrally formed. The body and the handle can share a center axis.

In some cases, the multi-purpose driver tool can be combined with an extension arm. The extension arm can have an elongate arm having a rounded outer surface, a first face on a first end, and a second face on a second end, and a hex shaft protruding from the first face of the elongate arm. The first, second, and third hex sockets can be configured to receive the hex shaft of the extension arm. The elongate arm can have a width that is larger than a width for any of the first, second, and third hex sockets. The first face of the elongate arm may be wider than the width of the first, second, and third hex sockets, thereby preventing the elongate arm from insertion into the first, second, or third hex sockets. At least the second and third hex sockets can each have a solid bottom.

In another illustrative but non-limiting example, the disclosure provides a method of using a multi-purpose driver. The method includes the steps of grasping a tool having a body and a handle, grasping an extension arm having an elongate arm and a hex shaft, and inserting the hex shaft of the extension arm into either of the at least two hex sockets of the tool body. The tool body can include at least two hex sockets, the tool body can define the at least two hex sockets, and the at least two hex sockets can be located on a same side of the tool body. Insertion of the hex shaft can be complete when either the hex shaft bottoms out on a surface of the tool body, or a flat face of the elongate arm makes contact with an outer surface of the tool body.

In some cases, insertion of the hex shaft into a first of the at least two hex sockets can create a long-reach driver, and insertion of the hex shaft into a second of the at least two hex sockets can create a t-handle. Further, the first hex socket may be disposed near a first end of the body, and the second hex socket may be disposed near a second, opposite end of the body, wherein the second end of the body may be located within a central third portion along a length of the tool.

The above summary is not intended to describe each and every example or every implementation of the disclosure. The Description that follows more particularly exemplifies various illustrative embodiments.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a rear view of a multi-purpose driver having a tool and an extension arm.

FIG. 2 is a perspective front view of the tool.

FIG. 3 is a perspective rear view of the tool.

FIG. 4 is a front view of the tool.

FIG. 5 is right side view of the tool; the left side view of the tool is a mirror image.

FIG. 6 is a rear view of the tool.

FIG. 7 is a top view of the tool.

FIG. 8 is a bottom view of the tool.

FIG. 9 is a perspective top view of the extension arm.

FIG. 10 is a perspective bottom view of the extension arm.

FIG. 11 is a perspective view of the extension arm connected to the tool at a first location on the tool.

FIG. 12 is a perspective view of the extension arm connected to the tool at a second location on the tool.

FIG. 13 is a perspective view of the extension arm connected to the tool at a third location on the tool.

### DETAILED DESCRIPTION

This disclosure relates to a multi-purpose driver, and more particularly, relates to a driver having a tool body and handle with a plurality of connection points for an extension arm. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements, those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

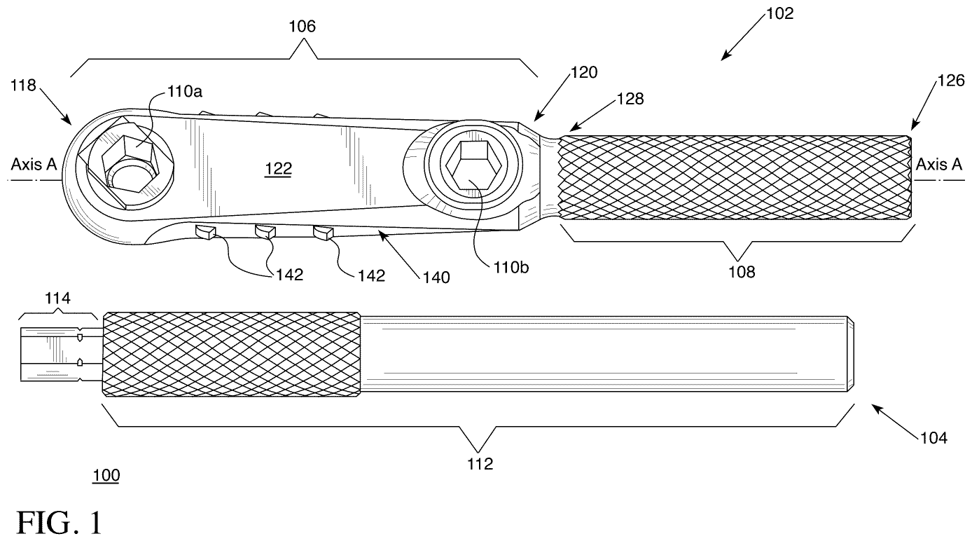

The present disclosure describes a multi-purpose driver that can aid users in managing difficult-to-reach or difficult-to-maneuver fasteners. FIGS. 1-10 illustrate the tool and extension arm of the multi-purpose driver.

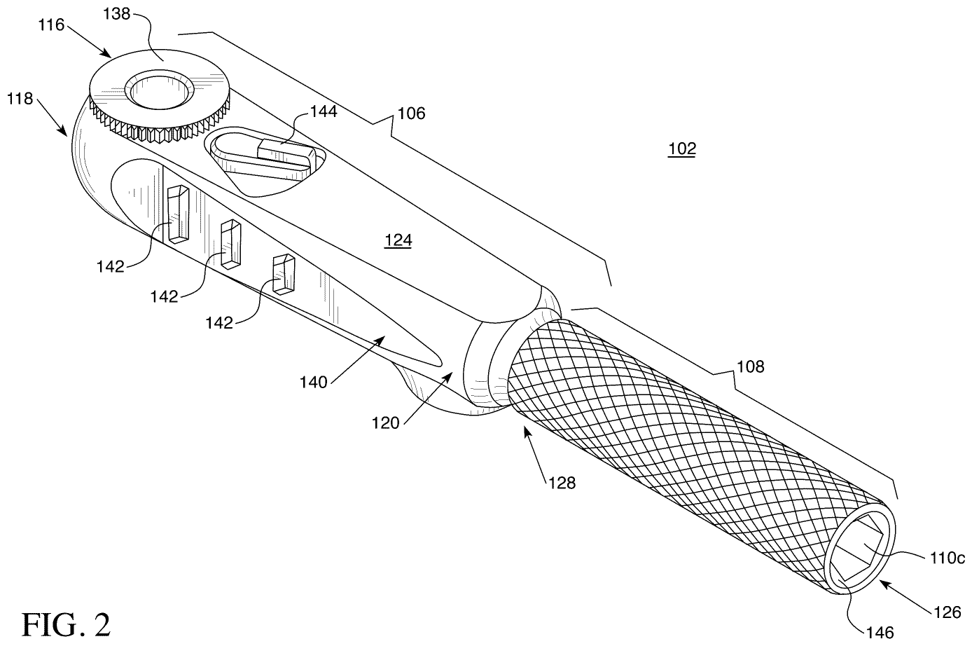

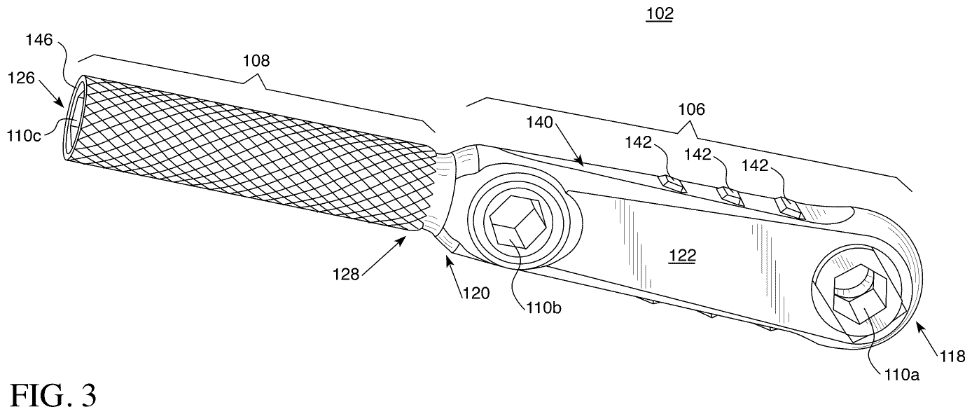

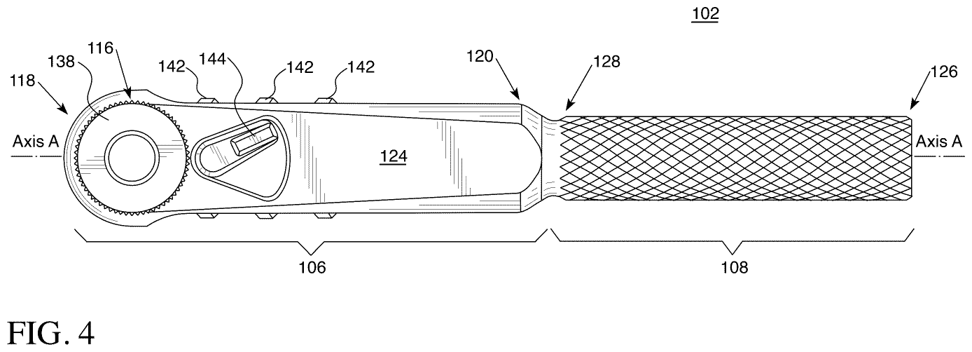

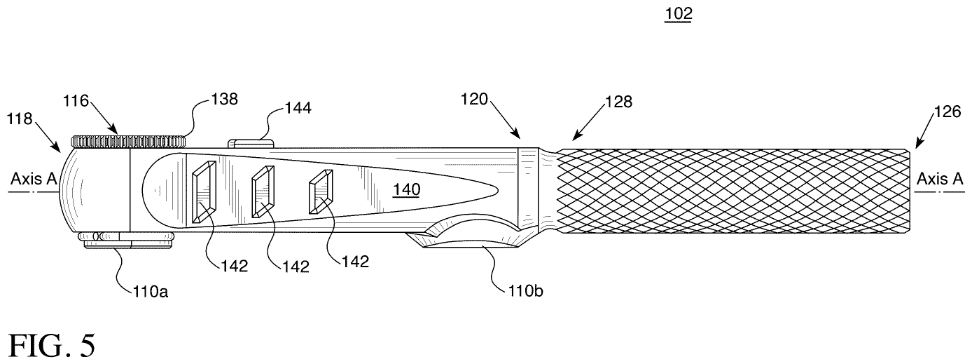

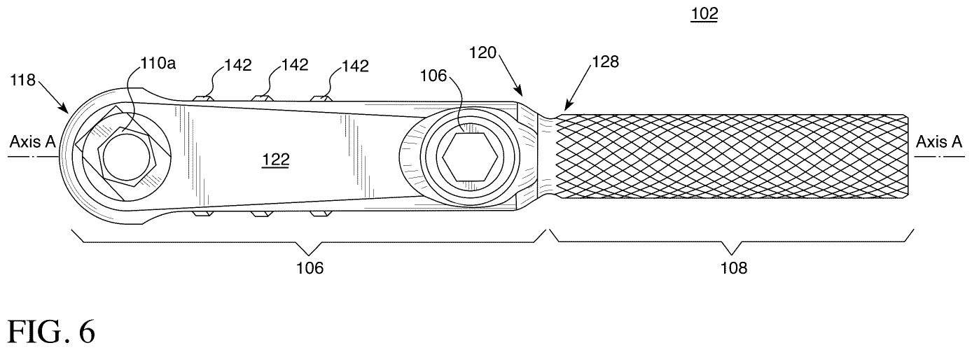

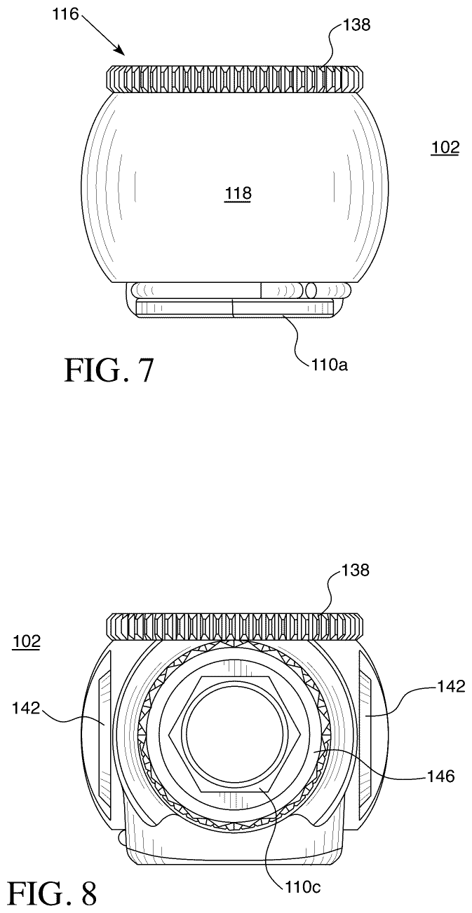

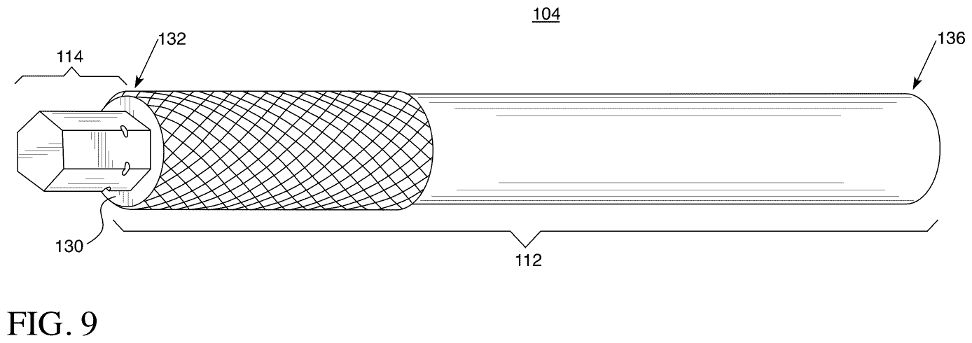

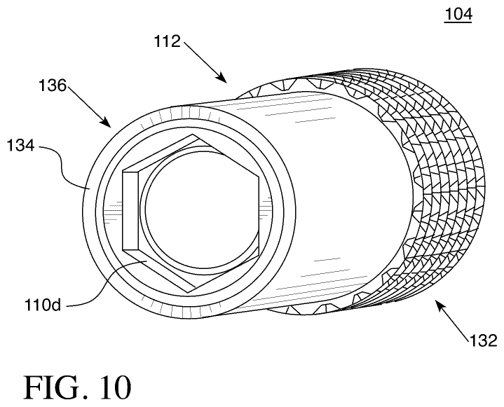

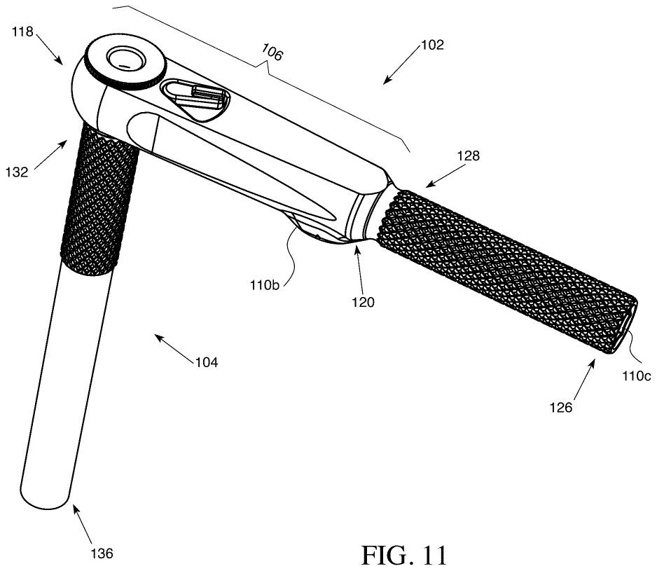

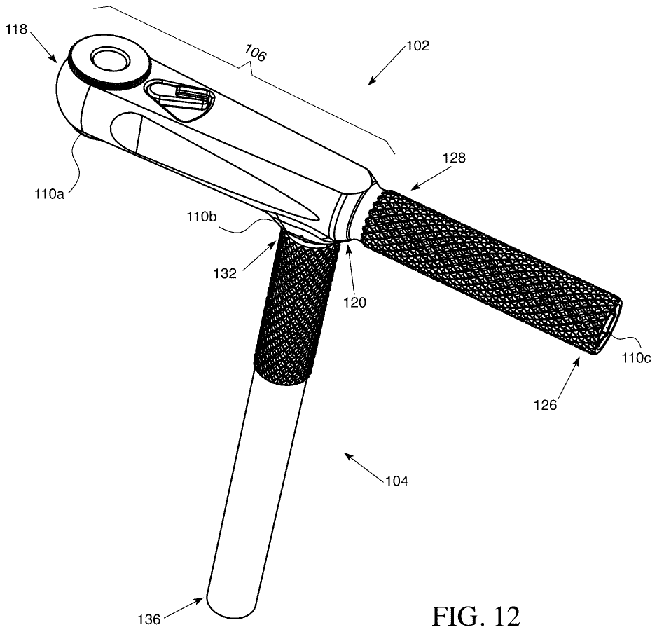

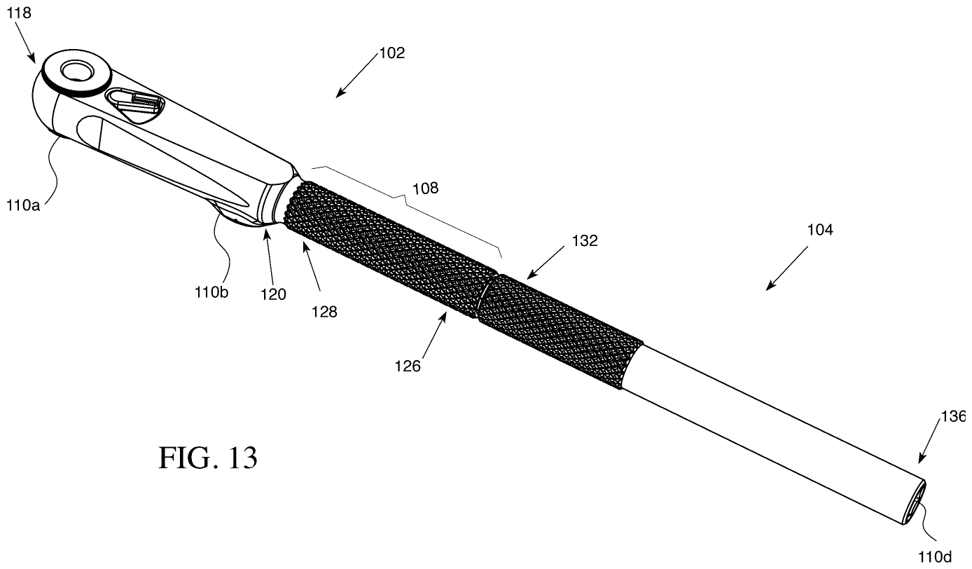

FIG. 1 is a rear view of a multi-purpose driver having a tool and an extension arm. FIG. 2 is a perspective front view of the tool. FIG. 3 is a perspective rear view of the tool. FIG. 4 is a front view of the tool. FIG. 5 is right side view of the tool; the left side view of the tool is a mirror image. FIG. 6 is a rear view of the tool. FIG. 7 is a top view of the tool. FIG. 8 is a bottom view of the tool. FIG. 9 is a perspective top view of the extension arm. FIG. 10 is a perspective bottom view of the extension arm. FIG. 11 shows the extension arm connected to the tool at a first location on the tool. FIG. 12 shows the extension arm connected to the tool at a first location on the tool. FIG. 13 shows the extension arm connected to the tool at a first location on the tool.

The multi-purpose driver of the present disclosure can readily connect to or engage with fasteners using a tool and an extension arm regardless of the fastener's difficult positioning within its device. The tool can include a body and a handle as well as multiple hex sockets for receiving a hex shaft that protrudes from an elongate arm of the extension arm. As described further herein, the multi-purpose driver can be primarily comprised of a main material such that the tool and the extension arm are comprised of the same material. For example, as illustrated herein, the multi-purpose driver 100 can be comprised of an extension arm 104 that can be transiently connected to the tool 102 at various locations on the tool body 106 and/or tool handle 108. More specifically, the tool body 106 and handle 108 can have a plurality of hex sockets 110 into which the hex shaft 114, located at one end of the elongate arm 112 of the extension arm 104, can be inserted. These various connections allow the multi-purpose driver to fit into hard-to-reach places due to, for example, a fastener being deep inside a narrow cavity, or facing a wall and having little clearance between the fastener and the wall, etc.

As illustrated in FIGS. 1-2, the tool 102 can be elongate and approximately cylindrical, and can be comprised of a metal (for example, steel, stainless steel, brass, titanium, or an aluminum alloy) or a composition of metals. Additionally, the tool can have a least a portion, such as the handle, that incorporates a textured surface, such as knurling, in order to increase friction between a user's fingers and the tool. In some cases, the tool can also have at least a portion, such as the body, that is mostly smooth.

More specifically, the tool 102 can have two primary portions: a body 106 and a handle 108. The body 106, as illustrated in FIG. 2, can have a first end 118 and a second end 120 that is opposite the first end of the tool, and the handle 108, as illustrated in FIG. 2, can have a first end 126 and a second end 128 that is opposite the first end of the handle. As illustrated in FIGS. 2-4 and 6-8 the first end 118 of the body 106 can be rounded or bulbous in shape such that it is wider than any other portion of the body. In some embodiments, the body's second end 120 can be integrally formed with the handle's second end 128 such that the two components are not separable from each other without damaging the tool 102. In other embodiments, however, the body and the handle may be transiently connected such that they can be manually separated (for example, using a friction fit or a threaded connection). Further, the body 106 and the handle 108 can share a center Axis A.

As mentioned above, the body 106 may have a mostly smooth surface while the handle 108 may have a mostly textured surface. In some embodiments, the body 106 can also have flat portions. More specifically, the body 106 can have at least two faces on opposing sides of the body, a first face 122 on front portion of the tool and a second face 124 on the rear portion of the tool, as illustrated in FIGS. 2 and 3. One or both of the faces 122, 124 can be relatively flat, such that they have no, or minimal, curvature. The sides 140 may also be flat or they may have some curvature. As illustrated in FIG. 5, the sides 140 may have both flat and curved portions. For example, one or both portions of the sides 140 nearest the first end 118 and the second end 120 may be curved while the space between the first and second ends may be relatively flat.

In addition to the shape, texture, and materials recited above, the body 106 and the handle 108 may include functional features. For example, the body 106 may have a ratchet 116 disposed near the first end 118 of the body, a toggle 144 in close proximity to the ratchet (i.e., on the same half of the body as the ratchet), a plurality of hex sockets 110, and a plurality of textured grips 142 on the sides of the body. The handle 108 may have a handle face 146 on the first end 126 of the handle and a hex socket 110 on, or integrated into, the handle face. The outer surfaces of the handle 108 other than the face 146 may be devoid of other tools or openings.

In some embodiments, the ratchet 116 can be comprised of a hex socket 110a and a ratchet wheel 138. The hex socket 110a, can be disposed near a first end 118 and on a first face 122 of the body 106, and can be configured to receive a hex shaft. For example, the first hex socket 110a can have a hex opening on the first face 122 of the body 106, wherein the first face can be on the rear portion of the tool 102. The ratchet wheel 138 can be located on the second face 124 of the body 106, which can be on the front portion of the tool 102 and can allow movement of the hex shaft within the hex socket 110a in one direction but limit it in the other direction. A toggle 144 may be included on either face 122/124 of the body 106, which allows the ratchet mechanism to change the direction the ratchet wheel 138 is permitted to move.

In addition to the first hex socket 110a that is associated with the ratchet 116, there may be a second hex socket 110b disposed near a second end 120 of the body 106. Therefore, the first and the second hex sockets 110a-b may be spaced apart from each other along the length of the tool 102 (the length of the tool being measure from the first end 118 of the body 106 to the first end 126 of the handle 108). For example, the first hex socket 110a and the second hex socket 110b may be at opposite ends of the tool body 106, as illustrated in FIGS. 1, 3 and 6. In some embodiments, the second hex socket 110b may be disposed on the same face as the first hex socket 110a. For example, as illustrated in FIG. 3, the first hex socket 110a and the second hex socket 110b are located on opposite ends of the body 106 and are both located on the first face 122. Further, as mentioned below, the base of the second hex socket 110b may be solid. Therefore, the second face 124 can appear smooth and/or devoid of any tools/connections at the location opposite on the second face that is opposite the second hex socket 11b, as illustrated in FIGS. 2, 4, and 12. However, this configuration may be modified in practice. For example, it is envisioned that the first hex socket 110a can be on an opposite face as the second hex socket 110b (i.e., the first hex socket on the second face and the second hex socket on the first face, or vice versa).

Regardless of location, the body 106 can define the shape, size, and specifications of the first hex socket 110a and the second hex socket 110b. Additionally, one or more of the hex sockets 110 can sit proud from the body 106 of the tool 102. For example, as illustrated in FIG. 5, an opening of the second hex socket 110b can sit proud from the body 106 of the tool 102. Further, while the location of the first hex socket 110a means it is in combination with the ratchet 116 and may result in a complete through hole through the body 106 of the tool 102, the second hex socket 110b may have a solid interior bottom such that a hex shaft cannot penetrate completely through the body of the tool if it is inserted into the second hex socket. Therefore, if a hex shaft is used that is longer than the thickness of the body 106, the entirety of the hex shaft may not penetrate completely into the tool body.

As mentioned above, the body 106 may also have a plurality of textured grips 142. These grips 142 can protrude out from the surface of the sides, as illustrated in FIGS. 4 and 6, and can provide a user with additional gripping strength when using the tool. As illustrated herein, the body 106 may include at least three textured grips 142 on each of the right and left sides of the tool 102. The grips 142 may be spaced equidistant from each other and may have similar height and length but varying widths. For example, as illustrated in FIG. 5, the grip nearest the first end 118 of the body 106 may be widest, and the grip nearest the second end 120 of the body may be narrowest. However, as illustrated in FIGS. 11-13, the textured grips 142 do not have to be present on the tool 102, so the sides 140 may be smooth and devoid of texturing or textured grips.

As mentioned above, the handle 108 may also have a hex socket 110. This third hex socket 110c can be defined by the handle 108, much as the first and second hex sockets 110a-b can be defined by the body 106. All three hex sockets 110a-c may have openings that are similar in size and shape. The third hex socket 110c can be located on a first end 126 of the handle 108, which, as mentioned above, may be located on an opposite end of the tool 102 than the first end 118 of the body 106. The opening for the third hex socket 110c can be located on a handle face 146 that is perpendicular to the first hex socket 110a. Further, unlike the opening of the second hex socket 110b, which may sit proud from the first face 122, as illustrated in FIG. 5, the opening of the third hex socket 110c may be flush or set in from the handle face 146. Similar to the second hex socket 110b, though, the third hex socket 110c may have a solid interior bottom, as illustrated in FIG. 8.

In addition to the tool 102, the multi-purpose driver 100 can include an extension arm 104, as illustrated in FIG. 1. The extension arm 104 can include at least an elongate arm 112 and a hex shaft 114 (i.e., a hex shaft having six sides and a flat outer facing surface on one end). In some cases, the extension arm 112 may include a length that is at least twice as long as a length of the hex shaft 114. For example, as illustrated in FIG. 1, the length of the extension arm 112 can be up to approximately nine times as long as the hex shaft 114 (for example, it might be three times longer, four times longer, five times longer, etc.). This ensures that, for example, when the hex shaft 114 is inserted into a hex socket, as illustrated in FIGS. 11-13, a large portion of the elongate arm 112 can remain exposed for a user to grip. Another benefit is that if the hex shaft 114 is inserted into an end of a tool (such as, for example, into hex socket 110c on tool 102), as illustrated in FIG. 13, enough of the elongate arm remains exposed to add substantial length to the combined tool and arm. Therefore, in some embodiments, the elongate arm 112 of the extension tool 104 may have a length that is at least 50% of a length of the tool 102. As illustrated in FIG. 1, the length of the elongate arm 112 may be up to ninety percent of the length of the tool 102 (for example, it could be between 50% and 75% the length of the tool or between 50% and 75% the length of the tool).

Similar to the tool 102, the extension arm 104 can have a rounded outer surface (for example, it may be approximately cylindrical) and can be comprised of a metal (for example, steel, stainless steel, brass, titanium, or an aluminum alloy) or a composition of metals, and can have at least a first portion that incorporates a textured outer surface (for example, a knurled surface) in order to increase friction between a user's fingers and the extension arm. The extension arm 104 can also have a second portion that is mostly smooth. As illustrated in FIG. 1, the textured surface may take up less than half of the area of the elongate arm 112 and can be dispersed closer to, and inclusive of, a first end 132 of the elongate arm than a second end 136. However, it's also possible that the textured and smooth surfaces are equally distributed along the elongate arm, that the textured surface is closer to the second end than the first end, that the textured surface is more centrally located with smooth portions on either side (or vice versa with the smooth portion more centrally located and surrounded by textured ends), or that there may be a greater amount of the arm with a textured surface compared to a smooth surface. In yet another embodiment, the elongate arm may be either entirely smooth or entirely textured. The hex shaft 114, as illustrated in FIG. 1, may be smooth to ensure a secure fit within the hex sockets 110.

As illustrated in FIGS. 9 and 10, the elongate arm 112 of the extension arm 104 can include a first end 132 and a second end 136, wherein a first face 130 can be located on the first end and a second face 134 can be located on the second end. The first and second faces 130, 134 can be relatively flat and/or smooth faces. As illustrated in FIG. 9, the hex shaft 114 can protrude from the first face 130 of the elongate arm 112 (for example, it can protrude perpendicularly from the plane of the first face of the elongate arm). And as illustrated in FIG. 10, the second face 134 on the second end 136 of the elongate arm 112 can include a fourth hex socket 110d. The elongate arm 112 can define the shape and depth of the fourth hex socket 11d such that the hex socket is, therefore, internal (or mostly internal) to the elongate arm similar to how the hex sockets 110a-c on the tool 102 are internal (or mostly internal) to the tool. And similar to the third hex socket 110c, the opening of the fourth hex socket 110d may be flush or set in from the second face 134 of the elongate arm 112.

While, as mentioned above, the first face 130 on the first end 132 can include the hex shaft 114 and the second face 134 on the second end 136 of the elongate arm 112 can include a fourth hex socket 110d, in some embodiments, the rounded, outer surface of the extension arm may otherwise be devoid of tools or other openings. Therefore, the circumference of the extension arm 112 may be devoid of tools or openings and the two faces 130, 134 on the two ends 132, 136 of the arm may each incorporate a shaft and/or an opening.

While each of the tool 102 and extension arm 104 have been described herein as separate components, it is envisioned that they have the ability to be combined, as illustrated in FIGS. 11-13. For example, the first 110a, second 110b, and third 100c hex sockets may be configured to receive the hex shaft 114 of the extension arm 104. Therefore, the hex shaft 114 may have a slightly smaller diameter/width than the diameter/width of the hex sockets 110a-c on the tool 102. In addition to the smaller diameter/width of the hex shaft 114 compared to the hex sockets 110, the length of the hex shaft may be smaller than the length of the hex sockets. However, in some cases, the length of the hex shaft may be equal to are larger than the length of one or more of the hex sockets 110. Further, the elongate arm 112 may have a diameter/width that is larger than the diameter/width of any of the first 110a, second 110b, and third 100c hex sockets. While the first face 130 of the elongate arm 112 may be slightly smaller in width/diameter than the outer surface of the arm, the first face can be larger/wider than the diameter/width of the first 110a, second 110b, and third 100c hex sockets, thereby preventing the elongate arm from insertion into the first, second, or third hex sockets.

In some embodiments, the fourth hex socket 110 d may be similarly sized to the first 110a, second 110b, and third 100c hex sockets. Therefore, if two or more extension arms 104 are combined together, the hex shaft 114 from a first extension arm may not only be compatible with any of the hex sockets 110, but it may also be compatible with the hex socket 110d from a second extension arm. Additionally, similar to the second 110b and third 110c hex sockets, the fourth hex socket 110cd may have a solid, interior bottom, as illustrated in FIG. 10.

In an example use case, a user can grasp a tool 102 having a body 106 and a handle 108, grasp an extension arm 104 having an elongate arm 112 and a hex shaft 114, and insert the hex shaft of the extension arm into either of at least two hex sockets 110 on the tool body. More specifically, the tool body 106 can include, and define, at least two hex sockets 110, and the at least two hex sockets can be located on the same side of the tool body. Therefore, the user can insert the hex shaft 114 of the extension arm 104 into either of the at least two hex sockets 110 of the tool body 106 until either the hex shaft bottoms out on a surface of the tool body or a flat face 130 of the elongate arm 112 makes contact with an outer surface of the tool body.

Insertion of the hex shaft 114 into a first of the at least two hex sockets 110 can create a long-reach ratchet driver, as illustrated in FIG. 11, and insertion of the hex shaft into a second of the at least two hex sockets can create a t-handle driver, as illustrated in FIG. 12. Therefore, the first hex socket 110a can be disposed near a first end 118 of the body 106 (the first end of the body being located near one end of the tool 102), and the second hex socket 110b can be disposed near a second, opposite end 120 of the body (the second end of the body being located within a central third portion along a length of the tool).

In some cases, the tool can include a third hex socket 110c that is located on a first end 126 of the handle 108, the first end of the handle being located on an opposite end of the tool 102 than a first end 118 of the body 106. Therefore, insertion of the hex shaft 114 into the third hex socket 110c on the handle 108 can create a long-reach driver, as illustrated in FIG. 13.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

What is claimed is:

1. A multi-purpose driver comprising:
a tool having
a body and a handle,
a ratchet with a first hex socket disposed near a first end of the body on a first face of the body,
a second hex socket disposed near a second end of the body, wherein the second end of the body is opposite the first end of the body, and
a third hex socket on a first end of the handle, the first end of the handle being located on an opposite end of the tool than the first end of the body, and an opening for the third hex socket being on a handle face that is perpendicular to the first hex socket,
wherein
the body defines the first hex socket and the second hex socket,
the handle defines the third hex socket,
a second face of the body is located opposite the first face of the body,
the second end of the body and a second end of the handle are integrally formed, and
the body and the handle share a center axis; and
an extension arm having
an elongate arm having a rounded outer surface, a first face on a first end, and a second face on a second end, and
a hex shaft protruding from the first face of the elongate arm,
wherein
the first, second, and third hex sockets are configured to receive the hex shaft of the extension arm,
the elongate arm has a width that is larger than a width for any of the first, second, and third hex sockets,
the first face of the elongate arm is wider than the width of the first, second, and third hex sockets, thereby preventing the elongate arm from insertion into the first, second, or third hex sockets,
at least the second and third hex sockets each have a solid interior bottom.

2. The driver of claim 1, wherein the elongate arm is cylindrical.

3. The driver of claim 1, wherein the second face of the elongate arm includes a fourth hex socket.

4. The driver of claim 1, wherein the second hex socket is located on the first face of the body.

5. The driver of claim 1, wherein the first face and the second face of the body are flat faces.

6. The driver of claim 1, wherein the first hex socket has a hex opening on the first face of the body and a ratchet wheel on the second face of the body.

7. The driver of claim 1, wherein the handle of the tool is knurled and at least a portion of the elongate arm is knurled inclusive of the rounded outer surface near the first end.

8. The driver of claim 1, wherein an opening of the second hex socket sits proud from the body of the tool.

9. The driver of claim 1, wherein the rounded outer surface of the extension arm is devoid of tools or openings.

10. The driver of claim 1, wherein the elongate arm of the extension arm has a length that is at least 50% of a length of the tool.

11. The driver of claim 1, wherein the elongate arm of the extension arm has a length that is at least twice as long as a length of the hex shaft.

12. The driver of claim 1, wherein the first, second, and third hex sockets have openings of a similar size.

13. A multi-purpose driver comprising:
a body and a handle,
a ratchet with a first hex socket disposed near a first end of the body on a first face of the body,
a second hex socket disposed near a second end of the body, wherein the second end of the body is opposite the first end of the body, and
a third hex socket on a first end of the handle, the first end of the handle being located on an opposite end of the tool than the first end of the body, and an opening for the third hex socket being on a handle face that is perpendicular to the first hex socket,
wherein
the body defines the first hex socket and the second hex socket,
the handle defines the third hex socket,
the first, second, and third hex sockets have openings of a similar size,
a second face of the body is located opposite the first face of the body,
the second end of the body and a second end of the handle are integrally formed, and
the body and the handle share a center axis.

14. The multi-purpose driver tool of claim 13 in combination with an extension arm, wherein the extension arm is comprised of
an elongate arm having a rounded outer surface, a first face on a first end, and a second face on a second end, and
a hex shaft protruding from the first face of the elongate arm,
wherein
the first, second, and third hex sockets are configured to receive the hex shaft of the extension arm,
the elongate arm has a width that is larger than a width for any of the first, second, and third hex sockets,
the first face of the elongate arm is wider than the width of the first, second, and third hex sockets, thereby preventing the elongate arm from insertion into the first, second, or third hex sockets,
at least the second and third hex sockets each have a solid bottom.

15. A method of using a multi-purpose driver, the method comprising:
grasping a tool having a body and a handle, wherein
the tool body includes at least two hex sockets,
the tool body defines the at least two hex sockets, and
the at least two hex sockets are located on a same side of the tool body;
grasping an extension arm having an elongate arm and a hex shaft; and
inserting the hex shaft of the extension arm into either of the at least two hex sockets of the tool body until either the hex shaft bottoms out on a surface of the tool body, or a flat face of the elongate arm makes contact with an outer surface of the tool body.

16. The method of claim 15, wherein insertion of the hex shaft into a first of the at least two hex sockets creates a long-reach ratchet driver, and insertion of the hex shaft into a second of the at least two hex sockets creates a t-handle driver.

17. The method of claim 16, wherein
the first hex socket is disposed near a first end of the body, and
the second hex socket is disposed near a second, opposite end of the body, the second end of the body being located within a central third portion along a length of the tool.

18. The method of claim 15, wherein the tool includes a third hex socket located on a first end of the handle, the first end of the handle being located on an opposite end of the tool than a first end of the body, and wherein insertion of the hex shaft into the third hex socket on the handle creates a long-reach driver.
